(19) United States
(12) Patent Application Publication
(10) Pub. No.: US 2021/0110217 A1
(43) Pub. Date: Apr. 15, 2021

(54) AUTOMOTIVE SENSOR FUSION

(71) Applicant: ZF Active Safety and Electronics US LLC, Livonia, MI (US)

(72) Inventor: Deniz Gunel, Clawson, MI (US)

(21) Appl. No.: 16/599,867

(22) Filed: Oct. 11, 2019

(51) Int. Cl. G06K 9/62; B60W 30/18; B60W 40/08; B60R 1/00; G06K 9/00; H04N 5/247; H04N 5/232; G01S 13/86; G01S 13/93; G01S 15/93

(52) U.S. Cl. CPC G06K 9/6288; B60R 11/04; B60W 40/08; B60R 1/00; G06K 9/00791; H04N 5/247; H04N 5/23238; G06K 9/00845; G01S 13/867; G01S 13/862; G01S 13/931; G01S 15/931; B60W 2420/42; B60W 2420/54; B60W 2520/10; B60W 2550/10; B60W 30/18

(57) ABSTRACT

Systems and methods fuse sensor data in a vehicle. The system includes an image processor formed as a first system on a chip (SoC) to process images obtained from outside the vehicle by a camera to classify and identify objects. A surround-view processor formed as a second SoC processes close-in images obtained from outside the vehicle by a surround-view camera to classify and identify obstructions within a specified distance of the vehicle. The close-in images are closer to the vehicle than the images obtained by the camera. An ultrasonic processor obtains distance to one or more of the obstructions, and a fusion processor formed as a microcontroller fuses information from the surround-view processor and the ultrasonic processor based on a speed of the vehicle being below a threshold value.

### INTRODUCTION

The subject disclosure relates to automotive sensor fusion.

A vehicle (e.g., automobile, truck, construction equipment, farm equipment, automated factory equipment) may include a number of sensors to provide information about the vehicle and the environment inside and outside the vehicle. For example, a radar system or lidar system may provide information about objects around the vehicle. As another example, a camera may be used to track a driver's eye movement to determine if drowsiness is a potential safety risk. Each sensor, individually, may be limited in providing a comprehensive assessment of the current safety risks. Accordingly, automotive sensor fusion may be desirable.

### SUMMARY

According to a first aspect, the invention provides a system to fuse sensor data in a vehicle, the system comprising an image processor formed as a first system on a chip (SoC) and configured to process images obtained from outside the vehicle by a camera to classify and identify objects, a surround-view processor formed as a second SoC and configured to process close-in images obtained from outside the vehicle by a surround-view camera to classify and identify obstructions within a specified distance of the vehicle, wherein the close-in images are closer to the vehicle than the images obtained by the camera, an ultrasonic processor configured to obtain distance to one or more of the obstructions, and a fusion processor formed as a microcontroller and configured to fuse information from the surround-view processor and the ultrasonic processor based on a speed of the vehicle being below a threshold value.

The surround-view processor also displays the obstructions identified and classified by the surround-view processor on a rear-view mirror of the vehicle.

A de-serializer provides the images obtained from outside the vehicle by the camera to the image processor and to provide the close-in images obtained by the surround-view camera to the surround-view processor.

An interior camera obtains images of a driver of the vehicle, wherein the de-serializer provides the images of the driver to the image processor or to the surround-view processor for a determination of driver state, the driver state indicating fatigue, alertness, or distraction.

A communication port obtains data from additional sensors and provides the data from the additional sensors to the fusion processor. The additional sensors include a radar system or a lidar system and the data from the additional sensors includes a range or angle to one or more of the objects.

The fusion sensor fuses information from the image processor and the additional sensors based on the speed of the vehicle being above a second threshold value.

A power monitoring module supplies and monitors power to components of the system. The components include the image processor, the ultrasonic processor, and the fusion processor.

The fusion processor obtains map information and provides output of a result of fusing combined with the map information to a display. The fusion processor generates haptic outputs based on the result of the fusing.

The fusion processor provides information to an advanced driver assistance system.

The information from the fusion processor is used by the advanced driver assistance system to control operation of the vehicle.

According to a second aspect, the invention provides a method to fuse sensor data in a vehicle, the method comprising obtaining images from outside the vehicle with a camera, processing the images from outside the vehicle using an image processor formed as a first system on a chip (SoC) to classify and identify objects, obtaining close-in images from outside the vehicle using a surround-view camera, processing the close-in images using a surround-view processor formed as a second SoC to identify and classify obstructions within a specified distance of the vehicle, the close-in images being closer to the vehicle than the images obtained by the camera, transmitting ultrasonic signals from ultrasonic sensors and receiving reflections; processing the reflections using an ultrasonic processor to obtain a distance to one or more of the objects; and fusing information from the surround-view processor and the ultrasonic processor using a fusion processor formed as a microcontroller based on a speed of the vehicle being below a threshold value.

The method may also include displaying the obstructions identified and classified by the surround-view processor on a rear-view mirror of the vehicle.

The method may also include providing the images obtained from outside the vehicle by the camera and the close-in images obtained by the surround-view camera to a de-serializer. Output of the de-serializer is provided to the image processor or to the surround-view processor.

The method also includes providing images of a driver of the vehicle from within the vehicle, obtained using an interior camera, to the de-serializer and providing the output of the de-serializer to the image processor or to the surround-view processor to determine driver state. The driver state indicates fatigue, alertness, or distraction.

The method also includes obtaining data from additional sensors using a communication port, and providing the data from the additional sensors to the fusion processor. The sensors include a radar system or a lidar system, and the data from the additional sensors including a range or angle to one or more of the objects.

The method also includes the fusion processor fusing information from the image processor and the additional sensors based on the speed of the vehicle being above a second threshold value.

The method also includes supplying and monitoring power to components of the system using a power monitoring module. The components include the image processor, the ultrasonic processor, and the fusion processor.

The method also includes the fusion processor obtaining map information and providing a result of the fusing combined with the map information to a display, and the fusion processor generating haptic outputs based on the result of the fusing.

The method also includes the fusion processor providing a result of the fusing to an advanced driver assistance system.

The method also includes the advanced driver assistance system using the result of the fusing from the fusion processor to control operation of the vehicle.

Objects and advantages and a fuller understanding of the invention will be had from the following detailed description and the accompanying drawings.

### BRIEF DESCRIPTION OF THE DRAWINGS

For a better understanding, reference may be made to the accompanying drawings. Components in the drawings are not necessarily to scale. Like-referenced numerals and other reference labels designate corresponding parts in the different views.

FIG. 1 is a block diagram of an exemplary vehicle that implements automotive sensor fusion according to one or more embodiments of the invention;

FIG. 2 is a block diagram of an exemplary controller that implements automotive sensor fusion according to one or more embodiments of the invention; and

FIG. 3 is a process flow of a method of implementing automotive sensor fusion according to one or more embodiments.

### DETAILED DESCRIPTION

As previously noted, sensors may be used to provide information about a vehicle and the environment inside and outside the vehicle. Different types of sensors may be relied on to provide different types of information for use in autonomous or semi-autonomous vehicle operation. For example, radar or lidar systems may be used for object detection to identify, track, and avoid obstructions in the path of the vehicle. Cameras positioned to obtain images within the passenger cabin of the vehicle may be used to determine the number of occupants and driver behavior. Cameras positioned to obtain images outside the vehicle may be used to identify lane markings. The different types of information may be used to perform automated operations (e.g., collision avoidance, automated braking) or to provide driver alerts.

Embodiments of the inventive systems and methods detailed herein relate to automotive sensor fusion. Information from various sensors is processed and combined on the chip to obtain a comprehensive assessment of all conditions that may affect vehicle operation. That is, a situation that may not present a hazard by itself (e.g., vehicle is close to a detected road edge marking) may be deemed a hazard when coupled with other information (e.g., driver is distracted). The action taken (e.g., driver alert, autonomous or semi-autonomous operation) is selected based on the comprehensive assessment.

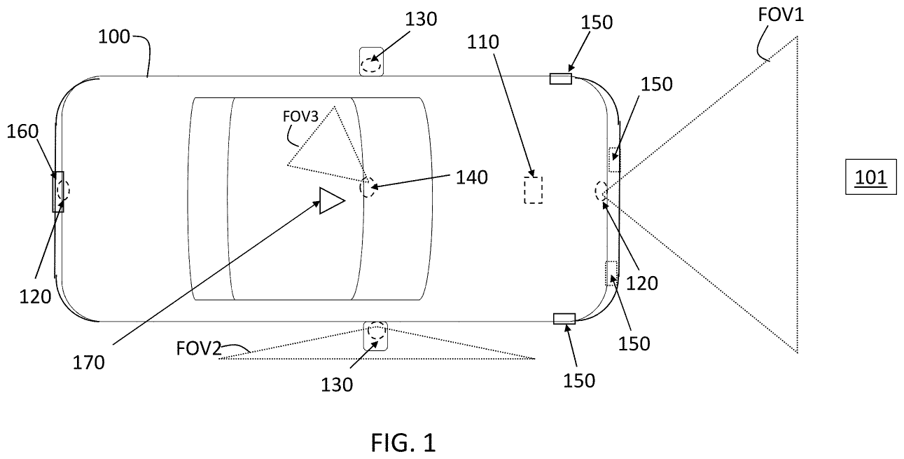

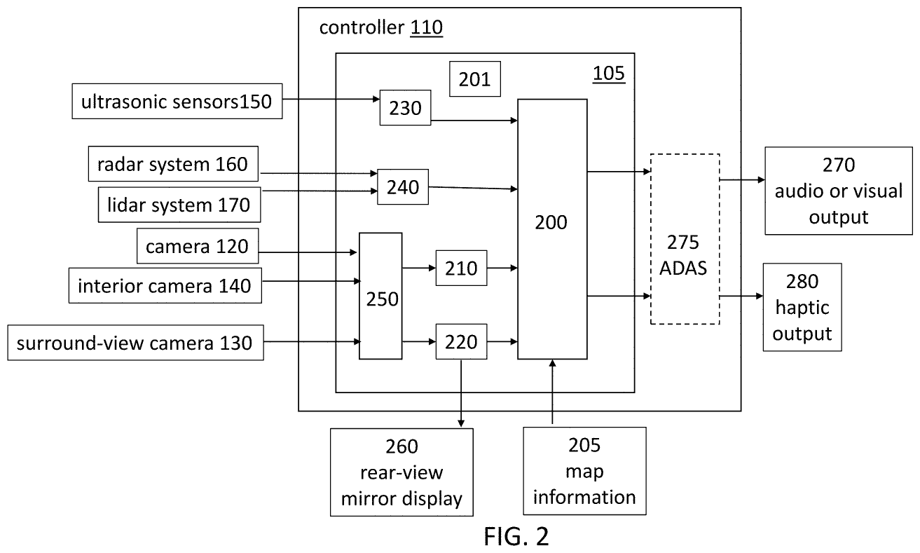

FIG. 1 is a block diagram of an exemplary vehicle 100 that implements automotive sensor fusion according to one or more embodiments of the invention. The vehicle 100 includes a controller 110 to implement the sensor fusion according to one or more embodiments. The controller 110 may be referred to as an electronic control unit (ECU) in the automotive field. Components of the controller 110 that are involved in the sensor fusion are further detailed with reference to FIG. 2. The controller 110 obtains data from several exemplary sensors. The controller 110 includes processing circuitry that may include an application specific integrated circuit (ASIC), an electronic circuit, one or more processors and one or more memory devices that execute one or more software or firmware programs, a combinational logic circuit, or other suitable components that provide the described functionality. The components of the controller 110 involved in the sensor fusion may be regarded as a multi-chip module, as further detailed.

The exemplary sensors shown for the vehicle 100 include cameras 120, surround-view cameras 130, an interior camera 140, ultrasonic sensors 150, a radar system 160, and a lidar system 170. The exemplary sensors and components shown in FIG. 1, generally, are not intended to limit the numbers or locations that may be included within or on the vehicle 100. For example, while the exemplary interior camera 140 is shown with a field of view FOV3 directed at a driver in a left-drive vehicle 100, additional interior cameras 140 may be directed at the driver or one or more passengers. One or more interior cameras 140 may include an infrared (IR) light emitting diode (LED).

As another example, there may be up to three cameras 120 and up to twelve ultrasonic sensors 150. The ultrasonic sensors 150 transmit ultrasonic signals outside the vehicle 100 and determine a distance to an object 101 based on the time-of-flight of the transmission and any reflection from the object 101. A comparison of the field of view FOV1 of the exemplary front-facing camera 120 to the field of view FOV2 of the exemplary surround-view camera 130 shown under the side-view mirror indicates that the FOV2 associated with the surround-view camera 130 is closer to the vehicle 100 than the FOV1.

FIG. 2 is a block diagram of an exemplary controller 110 that implements automotive sensor fusion according to one or more embodiments of the invention. Further reference is made to FIG. 1 in detailing aspects of the controller 110. The fusion processor 200 obtains and fuses information from other components. Those components include an image processor 210, a surround-view processor 220, an ultrasonic processor 230, and a communication port 240. Each of these components is further detailed. The fusion processor 200 may be a microcontroller.

The image processor 210 and the surround-view processor 220 obtain de-serialized data from a de-serializer 250. The de-serialized data provided to the image processor 210 comes from the one or more cameras 120 and, optionally, one or more interior cameras 140. The image processor 210 may be implemented as a system on chip (SoC) and may execute a machine learning algorithm to identify patterns in images from the one or more cameras 120 and, optionally, from the one or more interior cameras 140. The image processor 210 detects and identifies objects 101 in the vicinity of the vehicle 100 based on the de-serialized data from the one or more cameras 120. Exemplary objects 101 include lane markers, traffic signs, road markings, pedestrians, and other vehicles. Based on de-serialized data obtained from one or more interior cameras 140, the image processor 210 may detect driver state. That is, the de-serialized data may be facial image data from the driver of the vehicle 100. Based on this data, the image processor 210 may detect fatigue, drowsiness, or distraction. Information from the image processor 210 may be weighted more heavily by the fusion processor 200 (than information from other components) when the vehicle 100 is travelling at a speed exceeding a threshold (e.g., 30 kilometers per hour (kph)).

The de-serialized data provided to the surround-view processor 220 comes from the one or more surround-view cameras 130 and, optionally, one or more interior cameras 140. The surround-view processor 220, like the image processor 210, may be implemented as a SoC and may execute a machine learning algorithm to identify and report patterns. The surround-view processor 220 may stitch together the images from each of the surround-view cameras 130 to provide a surround-view (e.g., 360 degree) image. In addition to providing this image to the fusion processor 200, the surround-view processor 220 may also provide this image as a rear-view mirror display 260. As previously noted with reference to the image processor 210, when images from the interior camera or cameras 140 are provided to the surround-view processor 220, the surround-view processor 220 may detect driver state (e.g., fatigue, drowsiness, or distraction). Information from the surround-view processor 220 may be weighted more heavily by the fusion processor 200 (than information from other components) when the vehicle 100 is travelling at a speed below a threshold (e.g., 10 kph). The information from the surround-view processor 220 may be used during parking, for example.

The ultrasonic processor 230 obtains the distance to objects 101 in the vicinity of the vehicle 100 based on time-of-flight information obtained by ultrasonic sensors 150. The fusion processor 200 may correlate the objects 101 whose distance is obtained by the ultrasonic processor 230 with objects 101 identified by the surround-view processor 220 during low-speed scenarios such as parking, for example. Noise and other objects 101 that are not of interest may be filtered out based on the identification by the image processor 210 or surround-view processor 220. The communication port 240 obtains data from the radar system 160, lidar system 170, and any other sensors. Based on the information from the sensors, the communication port 240 may convey range, angle information, relative velocity, lidar images, and other information about objects 101 to the fusion processor 200.

The fusion processor 200 obtains map information 205 for the vehicle 100 in addition to the information from processors of the controller 110. The fusion processor 200 may provide all the fused information (i.e., comprehensive information based on the fusion) to an advanced driver assistance system (ADAS) 275, according to an exemplary embodiment. This comprehensive information includes the objects 101 identified based on detections by the cameras 120 and surround-view cameras 130 as well as their distance based on the ultrasound sensors 150, driver state identified based on processing of images obtained by the camera 140, information from the sensors (e.g., radar system 160, lidar system 170), and map information 205. The information that is most relevant may be based on the speed for the vehicle 100, as previously noted. Generally, at higher speeds, information from the exterior cameras 120, radar system 160, and lidar system 170 may be most useful while, at lower speeds, information from the surround-view cameras 130 and ultrasonic sensors 150 may be most useful. The interior cameras 140 and information about driver state may be relevant in any scenario regardless of the speed of the vehicle 100.

Based on the comprehensive information, the ADAS 275 may provide an audio or visual output 270 (e.g., through the infotainment screen of the vehicle 100) of objects 101 indicated on the map. For example, the relative position of detected objects 101 to the vehicle 100 may be indicated on a map. The ADAS 275 may also provide haptic outputs 280. For example, based on the image processor 210 determining that images from one or more interior cameras 140 indicate driver inattention and also determining that images from one or more exterior cameras 120 indicate an upcoming hazard (e.g., object 101 in a path of the vehicle 100), the driver seat may be made to vibrate to alert the driver. The ADAS 275, which may be part of the controller 110, may additionally facilitate autonomous or semi-autonomous operation of the vehicle 100.

According to alternate embodiments, the fusion processor 200 may perform the functionality discussed for the ADAS 275 itself. Thus, the fusion processor 200 may directly provide an audio or visual output 270 or control haptic outputs 280. The fusion processor 200 may implement machine learning to weight and fuse the information from the image processor 210, surround-view processor 220, ultrasonic processor 230, and communication port 240. The controller 110 also includes a power monitor 201. The power monitor 201 supplies power to the other components of the controller 110 and monitors that the correct power level is supplied to each component.

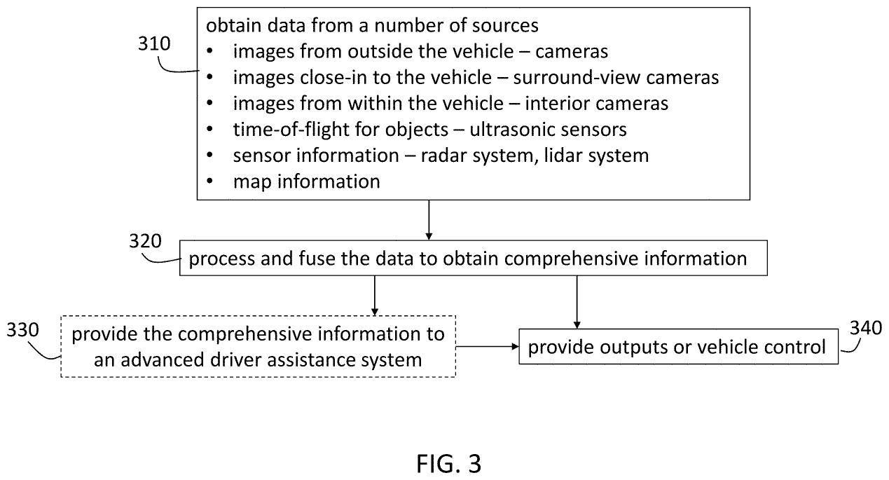

FIG. 3 is a process flow of a method 300 of implementing automotive sensor fusion using a controller 110 (i.e., ECU of the vehicle 100) according to one or more embodiments of the invention. Continuing reference is made to FIGS. 1 and 2 to discuss the processes. At block 310, obtaining data from a number of sources includes all the sources indicated in FIG. 3 and detailed with reference to FIG. 1. Images from outside the vehicle 100 are obtained by one or more cameras 120. Close-in images are obtained by surround-view cameras 130. Images from within the vehicle of the driver or, additionally, the passengers, are obtained by interior cameras 140. Ultrasonic sensors 150 emit ultrasonic energy and receive reflections from objects 101 such that time of flight of the ultrasonic energy may be recorded. A radar system 160 indicates range, relative velocity, and the relative angle to objects 101. A lidar system may also indicate range. Map information 205 indicates the position of the vehicle 100 using a global reference. As previously noted, not all of the sources are equally relevant in all scenarios. For example, in a low-speed scenario such as parking, the surround-view cameras 130 and ultrasonic sensors 150 may be more relevant than cameras 120 whose field of view is farther from the vehicle 100. In higher-speed scenarios such as highway driving, the cameras 120, radar system 160, and lidar system 170 may be more relevant.

At block 320, processing and fusing the data to obtain comprehensive information refers to using the various processors of the controller 110, as discussed with reference to FIG. 2. The image processor 210 and surround-view processor 220 process images to indicate objects 101 and determine driver state. These processors 210, 220 use a de-serializer 250 to obtain the images. The ultrasonic processor 230 uses the time-of-flight information from ultrasonic sensors 150 to determine the distance to objects 101. A communication port 240 obtains data from sensors such as the radar system 160 and lidar system 170. The fusion processor 200 weights and fuses the processed data to obtain comprehensive information. As previously noted, the weighting may be based on the speed of the vehicle 100.

As FIG. 3 indicates, the process at block 330 may be optional. This process includes providing the comprehensive information from the fusion processor 200 to an ADAS 275. Whether directly from the fusion processor 200 or through the ADAS 275, providing outputs or vehicle control, at block 340, may be performed. The outputs may be in the form of audio or visual outputs 270 or haptic outputs 280. The vehicle control may be autonomous or semi-autonomous operation of the vehicle 100.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A system configured to fuse sensor data in a vehicle, the system comprising:
an image processor formed as a first system on a chip (SoC) and configured to process images obtained from outside the vehicle by a camera to classify and identify objects;
a surround-view processor formed as a second SoC and configured to process close-in images obtained from outside the vehicle by a surround-view camera to classify and identify obstructions within a specified distance of the vehicle, wherein the close-in images are closer to the vehicle than the images obtained by the camera;
an ultrasonic processor configured to obtain distance to one or more of the obstructions; and
a fusion processor formed as a microcontroller and configured to fuse information from the surround-view processor and the ultrasonic processor based on a speed of the vehicle being below a threshold value.

2. The system according to claim 1, wherein the surround-view processor is further configured to display the obstructions identified and classified by the surround-view processor on a rear-view mirror of the vehicle.

3. The system according to claim 1, further comprising a de-serializer configured to provide the images obtained from outside the vehicle by the camera to the image processor and to provide the close-in images obtained by the surround-view camera to the surround-view processor.

4. The system according to claim 3, further comprising an interior camera configured to obtain images of a driver of the vehicle, wherein the de-serializer provides the images of the driver to the image processor or to the surround-view processor for a determination of driver state, the driver state indicating fatigue, alertness, or distraction.

5. The system according to claim 1, further comprising a communication port configured to obtain data from additional sensors and to provide the data from the additional sensors to the fusion processor, the additional sensors including a radar system or a lidar system and the data from the additional sensors including a range or angle to one or more of the objects.

6. The system according to claim 5, wherein the fusion sensor is configured to fuse information from the image processor and the additional sensors based on the speed of the vehicle being above a second threshold value.

7. The system according to claim 1, further comprising a power monitoring module configured to supply and monitor power to components of the system, the components including the image processor, the ultrasonic processor, and the fusion processor.

8. The system according to claim 1, wherein the fusion processor is further configured to obtain map information and provide output of a result of fusing combined with the map information to a display, and the fusion processor is further configured to generate haptic outputs based on the result of the fusing.

9. The system according to claim 1, wherein the fusion processor is configured to provide information to an advanced driver assistance system.

10. The system according to claim 9, wherein the information from the fusion processor is used by the advanced driver assistance system to control operation of the vehicle.

11. A method to fuse sensor data in a vehicle, the method comprising:
obtaining images from outside the vehicle with a camera;
processing the images from outside the vehicle using an image processor formed as a first system on a chip (SoC) to classify and identify objects;
obtaining close-in images from outside the vehicle using a surround-view camera;
processing the close-in images using a surround-view processor formed as a second SoC to identify and classify obstructions within a specified distance of the vehicle, wherein the close-in images are closer to the vehicle than the images obtained by the camera;
transmitting ultrasonic signals from ultrasonic sensors and receiving reflections;
processing the reflections using an ultrasonic processor to obtain a distance to one or more of the objects; and
fusing information from the surround-view processor and the ultrasonic processor using a fusion processor formed as a microcontroller based on a speed of the vehicle being below a threshold value.

12. The method according to claim 11, further comprising displaying the obstructions identified and classified by the surround-view processor on a rear-view mirror of the vehicle.

13. The method according to claim 11, further comprising providing the images obtained from outside the vehicle by the camera and the close-in images obtained by the surround-view camera to a de-serializer, wherein output of the de-serializer is provided to the image processor or to the surround-view processor.

14. The method according to claim 13, further comprising providing images of a driver of the vehicle from within the vehicle, obtained using an interior camera, to the de-serializer and providing the output of the de-serializer to the image processor or to the surround-view processor to determine driver state, the driver state indicating fatigue, alertness, or distraction.

15. The method according to claim 11, further comprising obtaining data from additional sensors using a communication port, and providing the data from the additional sensors to the fusion processor, wherein the sensors include a radar system or a lidar system, and the data from the additional sensors including a range or angle to one or more of the objects.

16. The method according to claim 15, further comprising the fusion processor fusing information from the image processor and the additional sensors based on the speed of the vehicle being above a second threshold value.

17. The method according to claim 11, further comprising supplying and monitoring power to components of the system using a power monitoring module, wherein the components include the image processor, the ultrasonic processor, and the fusion processor.

18. The method according to claim 11, further comprising the fusion processor obtaining map information and providing a result of the fusing combined with the map information to a display, and the fusion processor generating haptic outputs based on the result of the fusing.

19. The method according to claim 11, further comprising the fusion processor providing a result of the fusing to an advanced driver assistance system.

20. The method according to claim 19, further comprising the advanced driver assistance system using the result of the fusing from the fusion processor to control operation of the vehicle.
